(19) United States
(12) Patent Application Publication
(10) Pub. No.: US 2008/0232634 A1
(43) Pub. Date: Sep. 25, 2008

(54) SPEAKER WITH SOUND GENERATION PART OF LARGE AREA

(76) Inventors: Joon-Ho Park, Yangsan (KR); Hyuck-Joon Yoon, Busan (KR)

Correspondence Address: ST. ONGE STEWARD JOHNSTON & REENS, LLC, 986 BEDFORD STREET, STAMFORD, CT, 06905-5619, US

(21) Appl. No.: 11/933,852

(22) Filed: Nov. 1, 2007

(30) Foreign Application Priority Data
Mar. 20, 2007 (KR) 2007/27064
Mar. 20, 2007 (KR) 2007/27066

(51) Int. Cl. H04R 1/00

(52) U.S. Cl. 381/396

(57) ABSTRACT

A speaker with a sound generation part of a large area is provided. In the speaker, a ring-shaped protrusion part is formed at the outer circumference of the flange par in the frame, and also the inner surface of the outer circumference of the edge is coupled to the outer circumference of the protrusion. Moreover, the inner circumference of the outer end part of the edge is coupled to a step formed at the outer surface of the flange part in the frame.

### CROSS-REFERENCE TO RELATED APPLICATIONS

The present application claims priority from Korean patent application no. 10-2007-0027064, filed Mar. 20, 2007, and Korean patent application no. 10-2007-0027066, filed Mar. 20, 2007 the content of which is incorporated herein by reference.

### FIELD OF THE INVENTION

The present invention relates to a speaker with a sound generation part of a large area.

### BACKGROUND OF THE INVENTION

A speaker is an electromechanical device converting an electric signal into vibration of a diaphragm such that a longitudinal wave is generated in air, thereby sound wave radiates.

FIGS. 1A and 1B are sectional views of a conventional speaker.

As illustrated in FIG. 1A, a frame 11 includes an opened top and a bottom portions, a through-hole 11a is formed on a middle portion of the bottom portion of the frame 11.

The frame 11 includes a horizontal flange part 13 on a top portion and a vertical flange part 15 extending toward the top at the outer circumference of the horizontal flange part 13. A sound generation part 21 is coupled to the horizontal flange part 13.

The sound generation part 21 includes an edge 22 and a diaphragm 23. The edge 22 has a ring shape and the bottom of the outer circumference is coupled to the horizontal flange part 13. The diaphragm 23 has a cone shape and is coupled to the bottom of the inner circumference of the edge 22. Therefore, when power is applied to a voice coil 31, the voice coil 31 vibrates, which is caused due to electromagnetic force generated between the voice coil 31 and a magnetic circuit part (not shown). The magnetic circuit part is coupled to the bottom portion of the frame 11 near the through-hole 11a. Consequently, the sound generation part 21 vibrates, thereby generates a sound.

Among reproducible sound range in the speaker, a middle and bass range sound quality is determined according to the area of the sound generation part 21, i.e., the diameter of the sound generation part 21.

According to the conventional speaker, however, the outer circumference of the diaphragm 23 is coupled to the horizontal flange part 13 and thus the diameter of the sound generation part 21 shortens by a portion of the edge 22, which contacts the horizontal flange part 13. Therefore, the middle and bass range sound quality is reduced by a shortened area of the sound generation part 21.

To resolve the above problem, as illustrated in FIG. 1B, Korean Patent Publication No. 2003-66822 discloses “SPEAKER SURROUND STRUCTURE MAXIMIZING CONE DIAMETER”, in which the top at the outer circumference of skirt 16a in a surround-suspension 16 combines with the inner surface at an top of a basket 10.

According to the Korean Patent Publication No. 2003-66822, the outer circumference of the skirt 16a in the surround-suspension 16, which vibrates up and down, contacts the inner surface of the top of the basket 10. Therefore, the contact portions of the basket 10 and the skirt 16a are mutually pressed, such that it is difficult to attach to each other.

Moreover, when considering a vibration direction of the surround-suspension 16 that vibrates up and down, the surround-suspension 16 may be torn down, due to crack of the attached portion between the basket 10 and the skirt 16a while moving the surround-suspension 16.

### SUMMARY OF THE INVENTION

An object of the present invention is to provide a speaker capable of improving a sound quality in middle and bass range.

Embodiments of the present invention provide a speaker including: a frame including a ring-shaped flange part, a cone-shaped receiving part, and a ring-shaped protrusion part, the cone-shaped receiving part extending toward one side of a vertical direction of the flange part at the inner circumference of the flange part, the ring-shaped protrusion part protruding in a direction opposite to the receiving part at the outer circumference of the flange part; a sound generation part including an edge and a diaphragm, the edge having a ring-shaped curved part and a flat part, the ring-shaped curved part coupling the inner surface at the outer end part to the outer circumference of the protrusion part, the flat part protruding from the inner end part of the curved part, the diaphragm having the outer circumference coupled to the flat part; a magnetic circuit part coupled to the receiving part and generating a magnetic force; and a voice coil coupled to the diaphragm and vibrating through an operation with the magnetic circuit part to vibrate the sound generation part when power is applied.

In other embodiments of the present invention, a speaker includes: a frame including a ring-shaped flange part and a cone-shaped receiving part, the flange part having a step at the outer circumference of one surface, the receiving part extending at the other surface of the flange part; a sound generation part including an edge and a diaphragm, the edge having a ring-shaped combination part, a ring-shaped connection part, a ring-shaped curved part, and a ring-shaped flat part, the combination part being coupled to the step of the flange part, the connection part extending toward the inner of the frame at one side of the combination part corresponding to the one surface of the flange part, the curved part extending at the inner circumference of the connection part, the flat part extending at the inner circumference of the curved part, the diaphragm having the outer circumference coupled to the flat part; a magnetic circuit part coupled to the receiving part and generating a magnetic force; and a voice coil coupled to the diaphragm and vibrating by an operation with the magnetic circuit part to vibrate the sound generation part when power is applied.

### BRIEF DESCRIPTION OF THE DRAWINGS

The above objects and other advantages of the present invention will become more apparent by describing in detail preferred embodiments thereof with reference to the attached drawings in which:

FIGS. 1A and 1B are sectional views of a conventional speaker;

FIG. 2 is a sectional view of a speaker according to a first embodiment of the present invention;

FIG. 3 is an enlarged view of section A of FIG. 2;

FIGS. 4 through 7B are views of a structure combining a frame and a sound generation part in a speaker according to second through eighth embodiments of the present invention;

FIG. 8 is a sectional view of a speaker according to a ninth embodiment of the present invention;

FIG. 9 is an enlarged view of section B of FIG. 8; and

FIGS. 10 through 14 are views of a structure combining a frame and a sound generation part in a speaker according to tenth through fourteenth embodiments of the present invention.

### DETAILED DESCRIPTION OF THE INVENTION

Now, preferred embodiments of the present invention will be described in detail with reference to the accompanying drawings.

As to a same component having a same structure, same symbol is used.

### First Embodiment

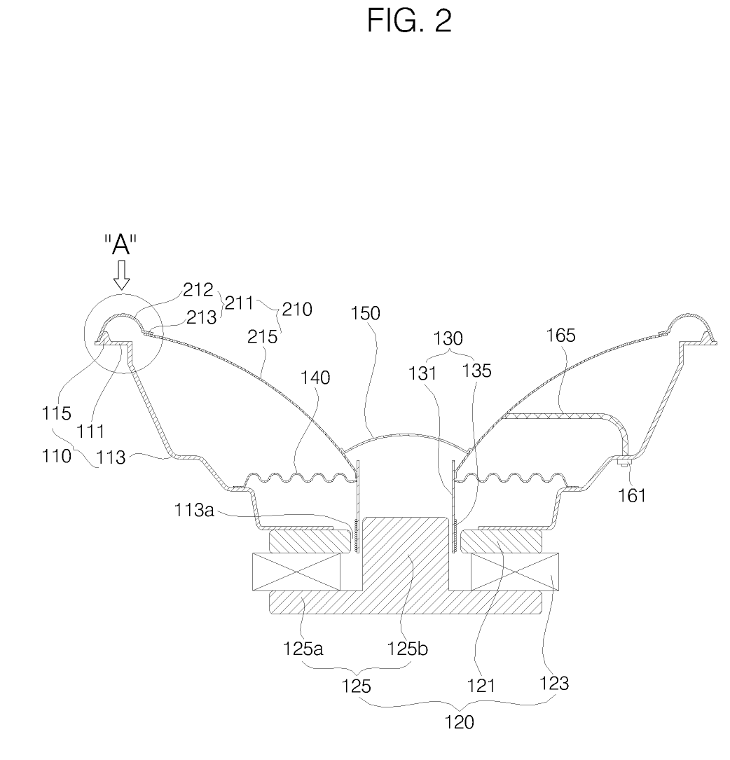

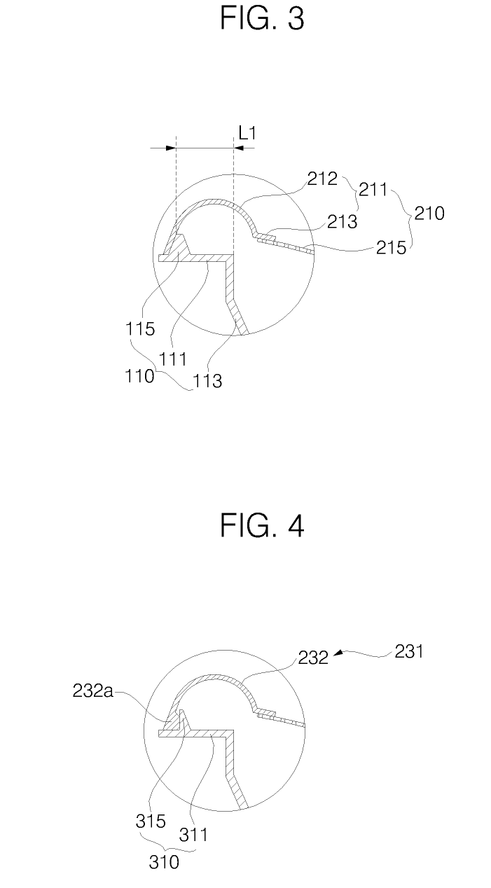

FIG. 2 is a sectional view of a speaker according to a first embodiment of the present invention. FIG. 3 is an enlarged view of section A of FIG. 2.

As illustrated in FIGS. 2 and 3, the speaker of the first embodiment includes a ring-shaped flange part 111 and a receiving part 113. The receiving part 113 extends toward one side of a vertical direction of the flange part 111 to roughly form a cone shape, and includes a through-hole 113a in the middle portion.

Hereinafter, one side and one surface in a vertical direction of the flange part 111 are regarded as the bottom and the lower, and the other side and the other surface in the vertical direction of the flange part 111 are regarded as the top and the upper. Moreover, the top and bottom and the upper and lower of other components are named in correspondence to the flange part 111.

A ring-shaped plate 121 is coupled to the bottom of the receiving part 113 outside the through-hole 113a. A magnet 123 is coupled to the bottom of the plate 121, and a yoke 125 is coupled to the magnet 123. The yoke 125 includes a flange part 125a and a protruding 125b. The flange part 125a is attached to the bottom of the magnet 123. The protruding 125b protrudes from the middle of the flange part 125a toward the top to pass through the magnet 123 and the plate 121. The plate 121, the magnet 123, and the yoke 125 constitute a magnetic circuit part that generates a magnetic force.

A sound generation part 210 including an edge 211 and a diaphragm 215 is coupled to the top of the magnetic circuit part 120.

The edge 211 has a ring shape, and includes a curved portion 212 and a flat portion 213. A sectional view of the curved portion 212 has a bulge toward the top. The flat portion 213 extends from the inner end part of the curved portion 212. The diaphragm 215 has a cone shape with a coupling hall in the middle portion, and its outer circumference is coupled to the flat portion 213.

A voice coil 130 including a bobbin 131 and a coil 135 is coupled to the diaphragm 215. The outer circumference of the top the bobbin 131 is coupled to the inner circumference of the coupling hall in the diaphragm 215, and the outer circumference of the bottom of the bobbin 131 is disposed between the protruding portion 121 of the yoke 125 and the plate 121. The coil 135 is coiled into the outer circumference in the bottom of the bobbin 131.

Therefore, when an external power is applied to the coil 135, the voice coil 130 vibrates up and down, due to an electromagnetic force generated between the coil 135 and the magnetic circuit part 120. Then, the sound generation part 210 vibrates due to the voice coil such that a sound is reproduced.

A ring-shaped damper is placed in frame 110 of the bottom of the sound generation part 210. The outer circumference of the damper is coupled to the frame 110, and its inner circumference is coupled to the outer circumference of the bobbin 131. The damper 140 prevents the voice coil 130 from shaking when the voice coil 130 vibrates, thereby preventing the sound generation part 210 from being displaced.

A cap 150 is coupled to the top of the voice coil 130 in order to prevent foreign substance from being entered. A terminal plate 161 is installed on one side of the outer surface of the frame 110. The terminal plate 161 includes a tinsel wire 165 connected to the coil 135. An external power is applied to the coil 135 through the tinsel wire 165.

To improve a bass and middle sound quality among sound frequency ranges reproduced in the speaker, the area of the sound generation part 210, i.e., the diameter of the sound generation part 210, needs to be increased. The speaker of the present invention has a structure that lengthens the diameter of the sound generation part 210.

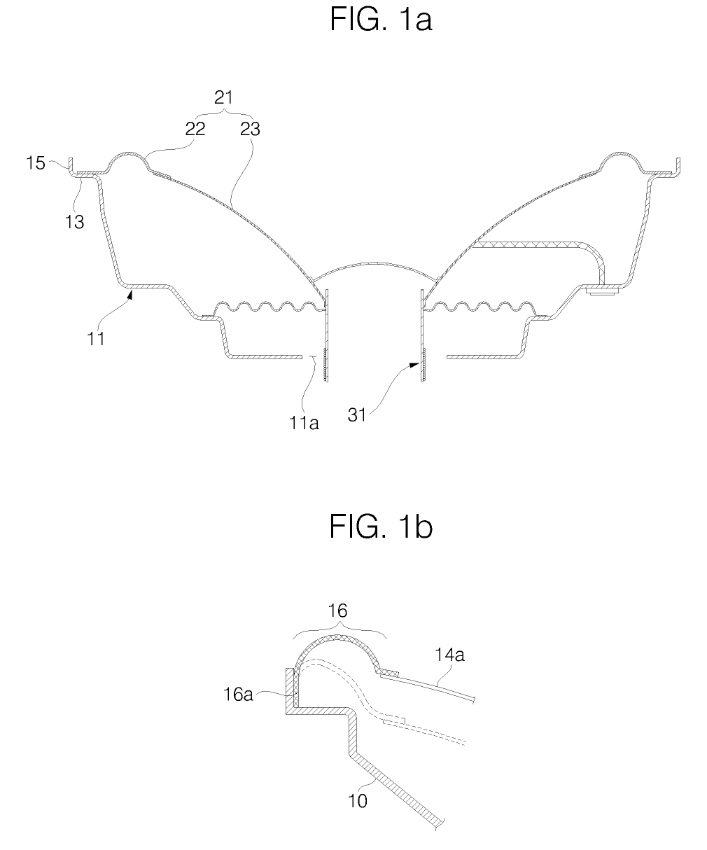

In more detail, the protrusion part 115 of a ring shape, of which a sectional view is trapezoid, protrudes toward the top at the outer circumference of the flange part 111, and the outer end part surface of the curved part 212 in the edge 211 is coupled to the outer end part inner surface of the protrusion part 115 toward the outer of the frame 110. Then, compared to a typical speaker in FIG. 1A, the diameter of the sound generation part 210 lengthens by the length L (referring to FIG. 3), which is from the protrusion part 115 to the inner circumference of the flange part 111. Therefore, a bass and middle range sound quality can be improved.

When pressing the curved part 212 of the edge 211 from the outside of the frame 110 toward the protrusion part 115, the curved part 212 can be closely attached to the protrusion part 115. This makes a manufacturing process easier. Moreover, when the sound generation part 210 vibrates toward the bottom, the curved part 212 can be more firmly attached to the protrusion part 115. Therefore, there is no possibility of the edge 211 disengaging from the protrusion part 115.

At this point, when the outer circumference of the protrusion part 115, where the curved part 212 of the edge 211 is attached, approaches toward the sectional top, it becomes closer to the middle of the frame 110, and tapers off.

### Second through Eighth Embodiments

Hereinafter, the definitions for the bottom and lower and the top and upper are the same like the first embodiment.

FIGS. 4 through 7B are views of a structure combining a frame and a sound generation part in a speaker according to second through eighth embodiments of the present invention.

As illustrated in FIG. 4, according to the speaker of the second embodiment, the outer circumference of the protrusion part 315 of a frame 310, where a curved part 232 of an edge 231 is attached, is formed in a direction perpendicular to a flange part 311. A protrusion part 232a protruding toward the inner is formed at the outer end part of the curved part 232, where the protrusion part 315 is attached. Due to the protrusion part 232a, an area for attachment between the edge 231 and the flange part 311 of the frame 310 increases. Thus, coherence between the edge 231 and the flange part 311 can be improved.

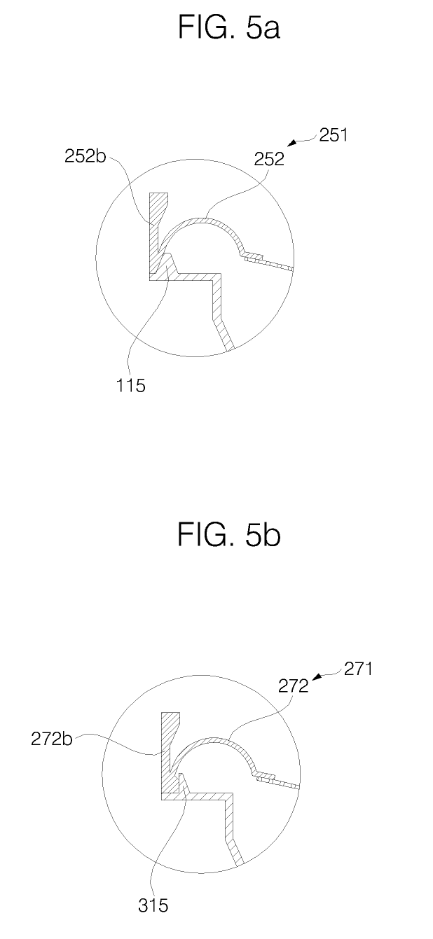

As illustrated in FIGS. 5A and 5B, according to the speaker of the third and fourth embodiments, extension parts 252b and 272b are disposed on the outer circumference of the protrusion parts 115 and 315, and extend on the end of the curved parts 252 and 272 in the edges 251 and 271. The extension parts 252b and 272b are coupled to a product in order to firmly attach the speaker to the product while installing the speaker to the product. And the extension parts 252b and 272b, when a sound generation part including the edges 251 and 271 vibrates, prevent the sound generation part from bumping against the product.

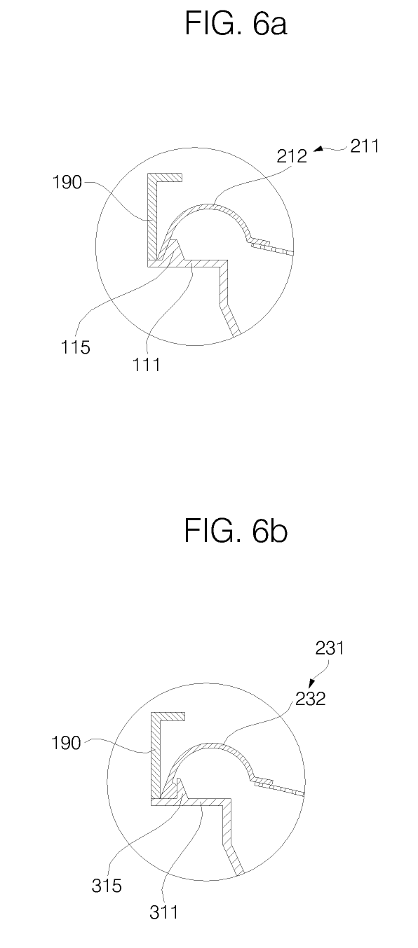

As illustrated in FIGS. 6A and 6B, according to the speaker of the fifth and sixth embodiments of the present invention, fixing members 190 are respectively coupled to the top at the outer circumference of the flange parts 111 and 311 in the outer of protrusion parts 115 and 315 where the edges 211 and 231 are combined. The fixing member 190 is coupled to a product in order to firmly attach the speaker to the product while installing the speaker to the product. And the fixing member 190, when a sound generation part including the edges 211 and 231 vibrates, prevents the sound generation part from bumping against the product.

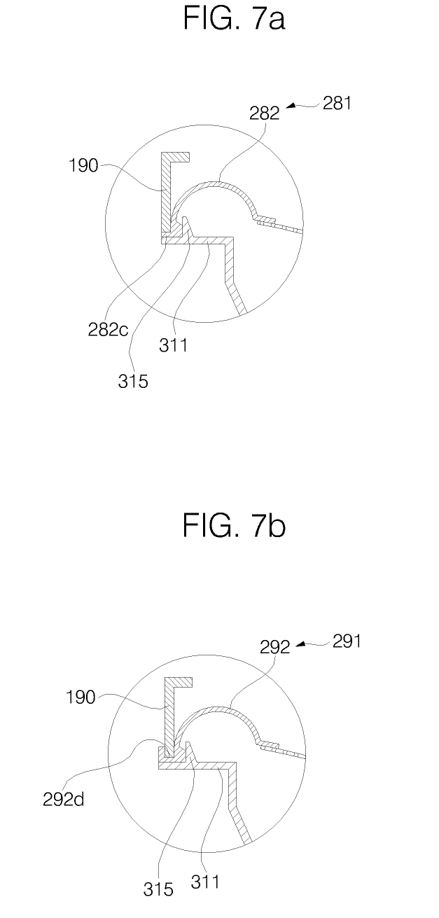

As illustrated in FIG. 7A, according to the speaker of the seventh embodiment, an extension part 282c parallel to the flange part 311 extends toward the outer direction of the flange part 311 at the outer end part of the curved part 282 of the edge 281 in order to couple to the flange part 311. The fixing member 190 is attached to the extension part 282c. This structure may be possible in the first embodiment.

As illustrated in FIG. 7B, according to the speaker of the eighth embodiment, a groove-shaped receiving part 292d is formed on the end of the curved part 292 of the edge 291. The bottom end portion of the fixing member 190 is vertically inserted to the receiving part 292d. This structure may be possible in the first embodiment.

### Ninth Embodiment

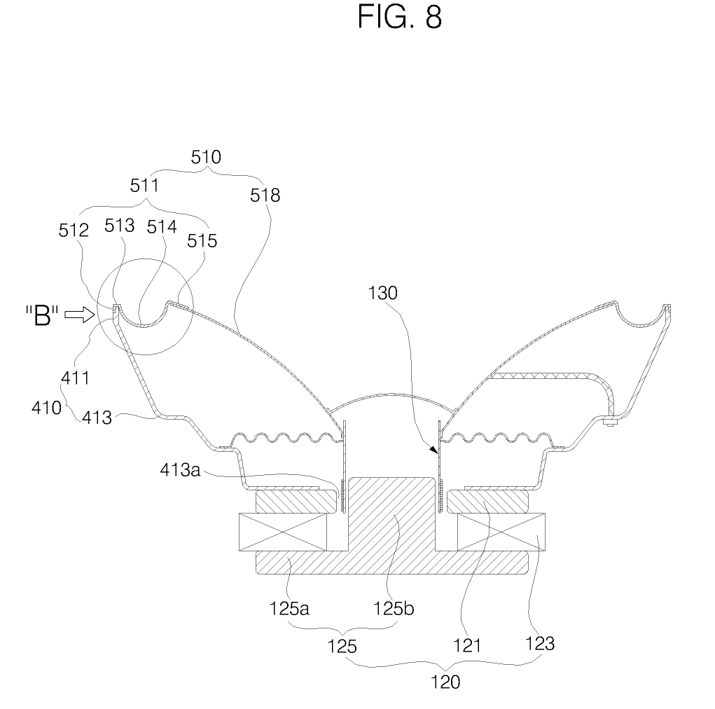

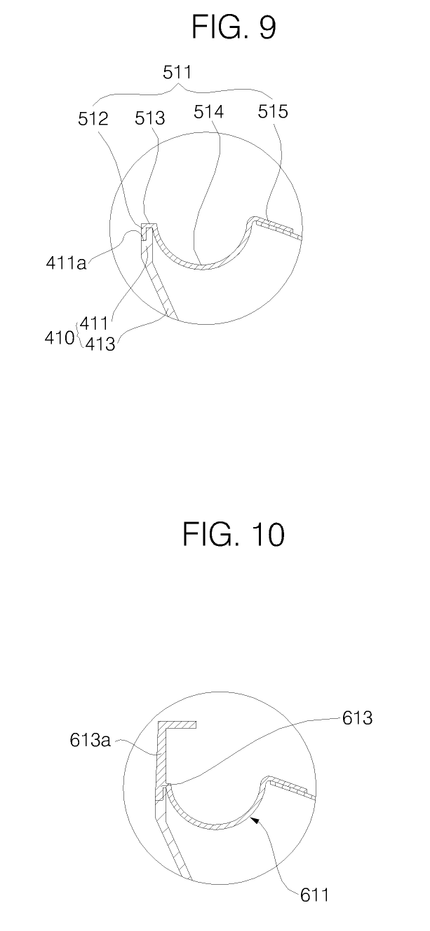

FIG. 8 is a sectional view of a speaker according to a ninth embodiment of the present invention. FIG. 9 is an enlarged view of section B of FIG. 8.

As illustrated in FIGS. 8 and 9, the speaker of the ninth embodiment includes a ring-shaped flange part 411, and a cone-shaped receiving part 413. The receiving part 413 extends from below a step 411a and includes a through-hole 413a in the middle. At this point, a step 411a is formed on one side of the outer circumference of the flange part 411, and the receiving part 413 extends from the other surface of the flange part 411.

Hereinafter, a direction where one surface of the flange part 411 is toward and one surface are regarded as the top and upper, and a direction where the other surface is toward and the other surface are regarded as the bottom and lower. The bottom and top and the lower and upper for other components are named in correspondence to the flange part 411.

Like FIG. 2, the magnetic circuit part 120 including the plate 121, the magnet 123, and the yoke 125 is coupled to the bottom of the receiving part 413 outside the through-hole 413a. The yoke 125 includes a flange part 125a and a protrusion part 125b.

A sound generation part 510 having an edge 511 and a diaphragm 518 is installed on the magnet circuit 120.

The edge 511 includes a combination part 512, a connection part 513, a curved part 514, and a flat part 515. The combination part 512 has a ring shape and the inner circumference coupled to the step 411a of the frame 410. The connection part 513 has a ring shape and extends inward from the top of the combination part 512. The curved part 514 extends at the inner circumference of the connection part 513 to form a ring shape, and its section has a bulge toward the bottom. The flat part 515 extends at the inner circumference of the curved part 514 to form a ring shape.

The diaphragm 518 has a cone shape with a coupling hole on the bottom middle portion, and its outer circumference is coupled to the flat part 515. Like FIG. 2, a voice coil 130 is coupled to the inner circumference of the coupling hole in the diaphragm 518.

The curved part 514 of the edge 511 expands while the sound generation part 510 vibrates in order to allow vibration of the sound generation part 510.

According to the speaker of the ninth embodiment, the inner circumference of the combination part 512 at the edge 511 is attached to the step 411a at the outer circumference of the flange part 411. Compared to the conventional speaker of FIG. 1A, the diameter of the sound generation part 510 lengthens by the length of the horizontal flange part 13 of frame 10. Therefore, a bass and middle range sound quality can be improved.

After attaching the combination part 512 of the edge 511 to the step 411a of the flange part 411, and then pressing the combination part 512 toward the flange part 411, the edge 511 is pressed to the frame 410 for attachment. This makes a manufacturing process easier.

Additionally, when the sound generation part 510 vibrates toward the bottom, the combination part 512 is more firmly attached to the flange part 411. Therefore, there is no possibility of the edge 511 disengaging from the flange part 411.

### Tenth through Fourteenth Embodiments

Hereinafter, the definitions for the bottom and lower and the top and upper are the same like the ninth embodiment.

FIGS. 10 through 14 are views of a structure combining a frame and a sound generation part in a speaker according to tenth through fourteenth embodiments of the present invention.

As illustrated in FIG. 10, according to the speaker of the tenth embodiment, a fixing part 613a protrudes in a predetermined direction toward the top of the connection part 613 of the edge 611. The fixing part 613a is used to fix a speaker to a product, such that the speaker is firmly installed to the product. And the fixing part 613a, when a sound generation part including the edge 611 vibrates, prevents the sound generation part from bumping against the product.

As illustrated in FIG. 11, according to the speaker of the eleventh embodiment, a fixing part 481 is attached to the top of the connection part 633 of the edge 631. The fixing part 481 is used to fix a speaker to a product, such that the speaker is firmly installed to the product. And the fixing part 481, when a sound generation part including the edge 631 vibrates, prevents the sound generation part from bumping against the product.

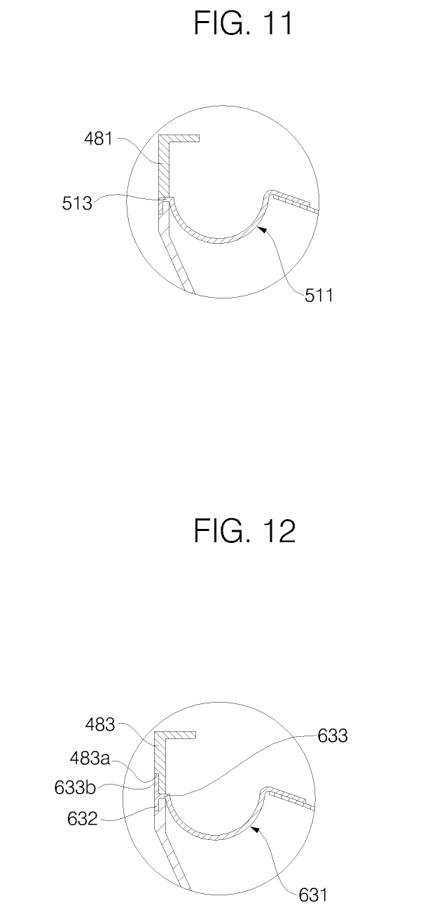

As illustrated in FIG. 12, according to the speaker of the twelfth embodiment, an extension part 633b is symmetric to the combination part 632 by using the axis of the connection part 633 as a reference line and extends at the top of the connection part 633 of the edge 631. Additionally, the extension part 633b protrudes in correspondence to the vertical part 632 at the end of the horizontal part 633. A step 483a, where the extension part 633b is coupled, is formed on the outer at the bottom of the fixing part 483.

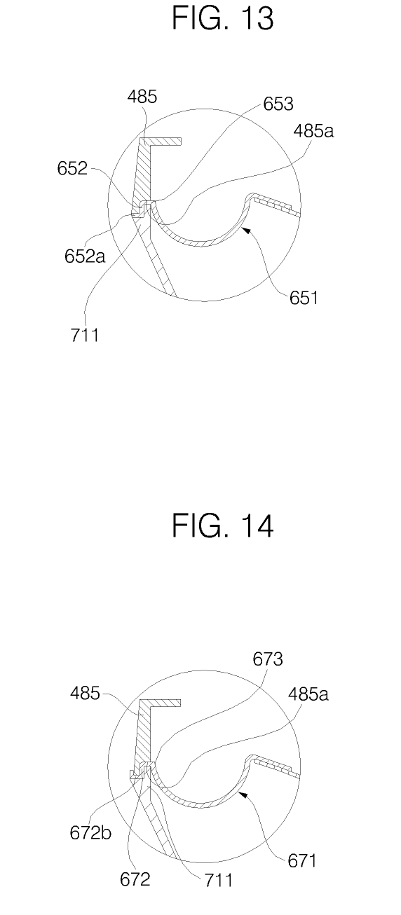

As illustrated in FIG. 13, according to the speaker of the thirteenth embodiment, an extension part 652a attached to the flange part 711 protrudes toward the outer direction of the bottom end part of the combination part 652 in the edge 651.

The step 485a corresponding to the extension part 652a, the combination part 652, and the connection part 653 are formed at the inner of the bottom end part of the fixing part 485, and the step 485a of the fixing part 485 are coupled to the extension part 652a, the combination part 652, and the connection part 653.

As illustrated in FIG. 14, according to the speaker of the fourteenth embodiment, a concave part 672b extends at the bottom end part of the combination part 672 of the edge 671.

Furthermore, the step 485a corresponding to the concave part 672b, the combination part 672, and the connection part 673 is formed at the inner of the bottom end part of the fixing part 485. When the step 485a of the fixing part 485 is inserted into the concave part 672b for combination, it is simultaneously coupled to the combination part 672 and the connection part 673.

As described above, according to the speaker of the present invention, the ring-shaped protrusion part is formed at the outer circumference of the flange part in the frame, and the inner of the outer circumference at the edge is coupled to the outer circumference of the protrusion part. Additionally, the inner circumference of the outer end part of the edge is coupled to the step that is formed on the flange part of the frame. Therefore, the diameter of the sound generation part including the edge lengthens, thereby improving middle and bass range sound quality.

While the present invention has been described in detail, it should be understood that various changes, substitutions and alterations can be made hereto without departing from the spirit and scope of the invention as defined by the appended claims.

What is claimed is:

1. A speaker comprising:
a frame including a ring-shaped flange part, a cone-shaped receiving part, and a ring-shaped protrusion part, the cone-shaped receiving part extending toward one side of a vertical direction of the flange part at the inner circumference of the flange part, the ring-shaped protrusion part protruding in a direction opposite to the receiving part at the outer circumference of the flange part;
a sound generation part including an edge and a diaphragm, the edge having a ring-shaped curved part and a flat part, the ring-shaped curved part coupling the inner surface at the outer end part to the outer circumference of the protrusion part, the flat part protruding from the inner end part of the curved part, the diaphragm having the outer circumference coupled to the flat part;
a magnetic circuit part coupled to the receiving part and generating a magnetic force; and
a voice coil coupled to the diaphragm and vibrating through an operation with the magnetic circuit part to vibrate the sound generation part when power is applied.

2. The speaker of claim 1, wherein the outer circumference of the protrusion part becomes closer to the middle of the frame as it approaches toward an end part.

3. The speaker of claim 1, wherein the outer circumference of the protrusion part is perpendicularly formed with respect to the flange part, and a protruding part protruding toward the inner is formed at the outer end part of the curved part.

4. The speaker of claim 2, further comprising an extension part extending toward a predetermined direction at the outer end part of the curved part.

5. The speaker of claim 2, further comprising a fixing member coupled to the outer circumference of the flange part.

6. The speaker of claim 2, further comprising:
an extension part parallel to the flange part and extending toward the outer direction of the flange part at the outer end part of the curved part; and
a fixing member coupled to the extension part.

7. The speaker of claim 2, further comprising:
a concave part extending at the outer end part of the curved part; and
a fixing member inserted into the concave part for coupling.

8. The speaker of claim 3, further comprising an extension part extending toward a predetermined direction at the outer end part of the curved part.

9. The speaker of claim 3, further comprising a fixing member coupled to the outer circumference of the flange part.

10. The speaker of claim 3, further comprising:
an extension part parallel to the flange part and extending toward the outer direction of the flange part at the outer end part of the curved part; and
a fixing member coupled to the extension part.

11. The speaker of claim 3, further comprising:
a concave part extending at the outer end part of the curved part; and
a fixing member inserted into the concave part for coupling.

12. A speaker comprising:
a frame including a ring-shaped flange part and a cone-shaped receiving part, the flange part having a step at the outer circumference of one surface, the receiving part extending at the other surface of the flange part;
a sound generation part including an edge and a diaphragm, the edge having a ring-shaped combination part, a ring-shaped connection part, a ring-shaped curved part, and a ring-shaped flat part, the combination part being coupled to the step of the flange part, the connection part extending toward the inner of the frame at one side of the combination part corresponding to the one surface of the flange part, the curved part extending at the inner circumference of the connection part, the flat part extending at the inner circumference of the curved part, the diaphragm having the outer circumference coupled to the flat part;
a magnetic circuit part coupled to the receiving part and generating a magnetic force; and
a voice coil coupled to the diaphragm and vibrating by an operation with the magnetic circuit part to vibrate the sound generation part when power is applied.

13. The speaker of claim 12, further comprising an extension part extending toward a predetermined direction at the connection part.

14. The speaker of claim 12, further comprising a fixing member coupled to the connection part.

15. The speaker of claim 14, further comprising:
an extension part extending symmetrically to the combination part by using the connection part as a reference line at the connection part; and
a step coupled to the extension part at the fixing member.

16. The speaker of claim 12, further comprising:
an extension part extending toward the outer direction of the flange member at the end part of the connection part facing toward the other surface of the flange part; and
a fixing member installed to combine with the extension part, the combination part, and the connection part,
wherein the fixing member includes a step corresponding to the extension part, the combination part, and the connection part.

17. The speaker of claim 12, further comprising:
a concave part extending at the end part of the connection part facing toward the other surface of the flange part; and
a fixing member inserted into and combined with the concave part and combined with the combination part and the connection part,
wherein the fixing member includes a step corresponding to the concave part, the combination part, and the connection part.
